(19) United States
(12) Patent Application Publication
(10) Pub. No.: US 2004/0030094 A1
(43) Pub. Date: Feb. 12, 2004

(54) Nucleated polyacetal molding materials having increased crystallization speed, their use and shaped molded bodies produced therefrom

(76) Inventors: Dirk Zierer, Hofheim (DE); Ursula Ziegler, Mainz (DE); Klaus Kurz, Kelsterbach (DE)

Correspondence Address: CONNOLLY BOVE LODGE & HUTZ, LLP, P O BOX 2207, WILMINGTON, DE, 19899, US

(21) Appl. No.: 10/399,279

(22) PCT Filed: Sep. 28, 2001
(86) PCT No.: PCT/EP01/11247

(30) Foreign Application Priority Data
Oct. 25, 2000 (DE) 100 52 763.9

(51) Int. Cl. C08G 65/34

(52) U.S. Cl. 528/425

(57) ABSTRACT

The invention relates to thermoplastic molding compositions comprising

A) polyoxymethylene homo- or copolymer

B) nucleating agent other than C), preferably talc

C) polyoxymethylene terpolymer

D) other additives.

The molding composition of the invention has increased crystallization rate, and is therefore capable of better and faster processing by various processing methods, such as injection molding, while at the same time good mechanical properties and low formaldehyde emission.

The invention relates to nucleated polyacetal molding compositions with increased crystallization rate, to their use for producing moldings, and also to a process for increasing the crystallization rate of polyacetal molding compositions.

The nucleation of polyacetal molding compositions in order to increase crystallization rate has long been known in principle. For example, DE 2037823 describes the use of talc and dolomite as nucleating agents. The use of branched or crosslinked polyacetal terpolymers as nucleating agents is disclosed in DE 2166377. It is known that the nucleating action of polyacetal terpolymer is weaker than the nucleating action of talc. When talc is used alone, however, the high formaldehyde emission is disadvantageous. It was thereby an object of the present invention to provide nucleated polyacetal molding compositions with increased crystallization rate, while at the same time achieving good mechanical properties and low formaldehyde emission. This object is achieved by a polyacetal molding composition comprising

A) polyoxymethylene homo- or copolymer

B) nucleating agent other than C), preferably talc

C) polyoxymethylene terpolymer

D) other additives,

where the totals of the proportions of A) to D) used are always 100%.

Particularly important for the invention here is the simultaneous use of the nucleating agent B), preferably talc, and of the polyacetal terpolymer C). Surprisingly, it has been found that the joint use of talc and polyacetal terpolymer gives an unexpected synergistic effect. When the two nucleating agents are used simultaneously, the crystallization rate increases. In one advantageous embodiment of the invention, the amount of the nucleating agents used may moreover be reduced, and therefore formaldehyde emission may be lowered, while the synergistic effect of the increase in the crystallisation rate is still observable.

Suitable components A) are the polyoxymethylene homo- or copolymers which were mentioned at the outset and which may also be termed polyacetals. The molding composition of the invention advantageously comprises from 25 to 99.9% by weight of polyoxymethylene, particularly advantageously from 50 to 99.8% by weight, very particularly advantageously from 60 to 99.5% by weight, in particular up to 99.25% by weight. These polymers are known to the skilled worker and have been described in the literature, e.g. in: Saechtling, Kunststoff-Taschenbuch [Plastics handbook], Hanser-Verlag, 27th edition, pp. 462-465, incorporated by way of reference. The polyoxymethylenes (POMs), for example those described in DE-A 29 47 490, are generally unbranched linear polymers which generally contain at least 80%, preferably at least 90%, of oxymethylene units (—CH₂O—). The term polyoxymethylenes or polyacetals here encompasses homopolymers of formaldehyde or of its cyclic oligomers, such as trioxane or tetroxane, and also appropriate copolymers.

Homopolymers of formaldehyde or of trioxane are polymers whose hydroxy end groups (hemiacetal end groups) have been chemically stabilized in a known manner with respect to degradation, e.g. by esterification or etherification. Copolymers are polymers of formaldehyde or of its cyclic oligomers, in particular trioxane, with cyclic ethers, with cyclic acetals, and/or with linear polyacetals.

POM-homo- or copolymers are known per se to the skilled worker and have been described in the literature. Very generally, these polymers have at least 50 mol % of —CH₂O— repeat units in the main polymer chain. The homopolymers are generally prepared by polymerizing formaldehyde or trioxane, preferably in the presence of suitable catalysts.

For the purposes of the invention, POM copolymers are preferred as component (A), in particular those which besides the —CH₂O— repeat units also contain up to 50 mol %, preferably from 0.1 to 20 mol %, and in particular from 0.5 to 10 mol %, of

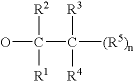

repeat units, where R¹ to R⁴, independently of one another, are a hydrogen atom, a C₁-C₄-alkyl group, or a halogen-substituted alkyl group having from 1 to 4 carbon atoms, and R⁵ is —CH₂—, —CH₂O—, a C₁-C₄-alkyl-substituted or C₁-C₄-haloalkyl-substituted methylene group, or a corresponding oxymethylene group, and n is value in the range from 0 to 3. These groups may advantageously be introduced into the copolymers via ring-opening of cyclic ethers. Preferred cyclic ethers are those of the formula

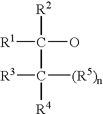

where R¹ to R⁵ and n are as defined above. Merely by way of example, mention may be made of ethylene oxide, propylene 1,2-oxide, butylene 1,2-oxide, butylene 1,3-oxide, 1,3-dioxane, 1,3-dioxolane, and 1,3-dioxepan as cyclic ethers, and also linear oligo- or polyformals, such as polydioxolane or polydioxepan as comonomers.

Copolymers of from 99.5 to 90 mol % of trioxane and from 0.5 to 10 mol % of one of the abovementioned comonomers are particularly advantageous. Processes for preparing the POM homo- and copolymers described above are known to the skilled worker and have been described in the literature.

The preferred POM copolymers have melting points of at least 150° C. and molecular weights (weight-average) M_{W} in the range from 5 000 to 200 000, preferably from 7 000 to 150 000. Particular preference is given to end-group-stabilized POMs whose chain ends have C-C bonds.

The POMs used generally have a melt index (MVR 190/2, 16) of from 1 to 50 cm³/10 min (ISO 1133).

Suitable components B), nucleating agents other than C) are in principle any of the known compounds, preferably compounds which have a nucleating action even when used in small amounts. The amount of component B) present in the molding composition of the invention may advantageously be from 0.0001 to 1% by weight, particularly advantageously from 0.001 to 0.8% by weight, very particularly advantageously from 0.01 to 0.3% by weight, in particular from 0.02 to 0.1% by weight.

Examples of suitable materials are valentinite, pyrophyllite, dolomite, melamine cyanurate, boron compounds, such as boron nitride, silica, montmorillonite, and also organically modified montmorillonite, organic or inorganic pigments, melamine-formaldehyde condensates, and phyllosilicates, where these form nanocomposites with polyacetal. Talc is in particular used as nucleating agent. Talc is a hydratized magnesium silicate whose formula is Mg₃[(OH)₂/Si₄O₁₀] or 3MgO×4 SiO₂×H₂O.

These “three-layer phyllosilicates” have a triclinic, monoclinic, or rhombic crystal structure, with platy appearance. Other trace elements which may be present are Mn, Ti, Cr, Ni, Na, and K, and the OH group here may be replaced to some extent by fluoride.

The amount of component C), polyoxymethylene terpolymer, present in the molding composition of the invention may be from 0.001 to 5% by weight, preferably from 0.01 to 3% by weight, in particular from 0.05 to 1% by weight, with preference from 0.1 to 0.5% by weight. Suitable polyoxymethylene terpolymers C) are oxymethylene terpolymers prepared, for example, by reacting trioxane with one of the cyclic ethers described above and with a third monomer, preferably an at least bifunctional glycidyl compound. Examples of advantageous bifunctional and trifunctional compounds are shown in formulae I and II.

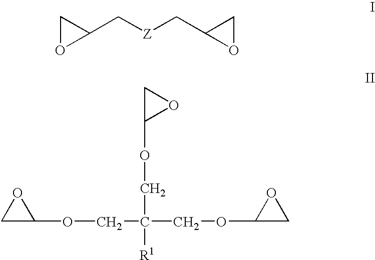

where Z is a chemical bond, —O—, or —ORO—(R═C₁-C₈-alkylene or C₂-C₈-cycloalkylene) and, respectively, R¹ is a hydrogen atom, a C₁-C₄-alkyl group, or a halogen-substituted alkyl group having from 1 to 4 carbon atoms.

Preferred monomers of this type are ethylene diglycide, diglycidyl ether, and diethers made from glycidyl compounds and formaldehyde, dioxane, or trioxane in a molar ratio of 2:1, and also diethers made from 2 mol of glycidyl compound and 1 mol of an aliphatic diol having from 2 to 8 carbon atoms, for example the diglycidyl ether of ethylene glycol, 1,4-butanediol, 1,3-butanediol, cyclobutane-1,3-diol, 1,2-propanediol, or cyclohexane-1,4-diol, and the trisglycidyl ether of trimethylolpropane, to mention just a few examples.

Processes for preparing the above polyoxymethylene terpolymers are known to the skilled worker and have been described in the literature.

Als component D), the molding compositions of the invention may comprise up to 70%, advantageously up to 50%, in particular up to 40%, of other additives, individually or as a mixture, for example fillers, such as calcium carbonate, glass beads, wollastonite, loam, which may be present at up to 50% by weight, preferably up to 40% by weight, molybdenum disulfide, carbon black, graphite, reinforcing materials, such as inorganic or organic fibers, e.g. glass fibers, carbon fibers, or aramid fibers, or potassium titanate whiskers, which may be present individually or in a mixture at up to 50% by weight, preferably up to 40% by weight, flow promoters and/or lubricants, such as oils, waxes, polyethylene waxes, and/or oxidized polyethylene waxes, and/or fatty esters or fatty amides, e.g. ethylene bisstearate and ethylenebisstearylamide, which may be used in amounts of from 0.01 to 10% by weight, advantageously from 0.05 to 3% by weight, particularly advantageously from 0.1 to 2% by weight, and thermoplastic or thermoset polymer additives, or elastomers, e.g. polyurethane, EPDM (ethylene-propylene-diene rubber), EPM (ethylene-propylene rubbers), polyester elastomers, copolymers of ethylene with esters of (meth)acrylic acid or (meth)acrylamides, or other polymers, e.g. polymethyl methacrylate, polybutadiene, polyethylene, polystyrene, or else graft copolymers whose core has been prepared by polymerizing buta-1,3-diene, isoprene, n-butyl acrylate, ethylhexyl acrylate, or a mixture of these, and whose shell has been prepared by polymerizing styrene, acrylonitrile, or (meth)acrylates.

Sterically hindered phenol compounds may advantageously be used as additive, the amount in particular being up to 2% by weight, advantageously from 0.1 to 1% by weight, particularly advantageously from 0.2 to 0.4% by weight. Examples of commercially available compounds of this type are pentaerithrityl tetrakis[3-(3,5-di-tert-butyl-4-hydroxyphenyl)propionate] (Irganox 1010, Ciba Geigy), triethylene glycol bis[3-(3-tert-butyl-4-hydroxy-5-methylphenyl)propionate] (Irganox 245, Ciba Geigy), 3,3′-bis[3-(3,5-di-tert-butyl-4-hydroxyphenyl)propionohydrazide] (Irganox MD 1024, Ciba Geigy), hexamethylene glycol bis[3-(3,5-di-tert-butyl-4-hydroxyphenyl)propionate] (Irganox 259, Ciba Geigy), 3,5-di-tert-butyl-4-hydroxytoluene (Lowinox BHT, Great Lakes). Preference is given to Irganox 1010 and especially to Irganox 245.

Other additives which may be used advantageously are UV stabilizers which derive from the group of the benzotriazol derivatives or benzophenone derivatives, or comprise aromatic benzoate derivative, in particular if they are added in amounts of from 0.0 to 1.0% by weight, preferably from 0.01 to 0.9% by weight, particularly preferably from 0.02 to 0.8% by weight. Preference is given to 2-[2′-hydroxy-3′,5′-bis(1,1-dimethylbenzyl)phenyl]benzotriazole, commercially available Tinuvin 234 (Ciba Geigy). Other advantageous additives are sterically hindered amines for light stabilization (HALS) in amounts of up to 1.0% by weight, advantageously from 0.01 to 0.5% by weight. Preference is given here to 2,2,6,6-tetramethyl-4-piperidyl compounds, e.g. bis(2,2,6,6-tetramethyl-4-piperidyl) sebacate (Tinuvin 770, Ciba Geigy) or the polymer made from dimethyl succinate and 1-(2-hydroxyethyl)-4-hydroxy-2,2,6,6-tetramethylpiperidine (Tinuvin 622, Ciba Geigy). The molding compositions of the invention may also comprise other conventional additives and processing aids. Merely by way of example, mention may be made of additives for scavenging formaldehyde (formaldehyde scavengers), acid scavengers, plasticizers, coupling agents, and pigments. The proportion of these additives is generally from 0.001 to 1.0% by weight. Formaldehyde scavengers suitable in principle are heterocyclic compounds having at least one nitrogen atom as heteroatom which is either adjacent to an amino-substituted carbon atom or to a carbonyl group, for example pyridazine, pyrimidine, pyrazine, pyrrolidone, aminopyridine, and compounds derived therefrom. Advantageous compounds of this nature are aminopyridine and compounds derived therefrom. Any of the aminopyridines is in principle suitable, e.g. melamine, 2,6-diaminopyridine, substituted and dimeric aminopyridines, and mixtures prepared from these compounds. Other advantageous materials are polyamides and dicyandiamide, urea and its derivatives, and also pyrrolidone and compounds derived therefrom. Examples of suitable pyrrolidones are imidazolidinone and compounds derived therefrom, such as hydantoin, the derivatives of which are particularly advantageous, and those particularly advantageous among these compounds are allantoin and its derivatives. Other particularly advantageous compounds are triamino-1,3,5-triazine (melamine) and its derivatives, such as melamine-formaldehyde condensates and methylolmelamine. Very particular preference is given to melamine, methylolmelamine, melamine-formaldehyde condensates, and allantoin. Oligomeric polyamides are also suitable in principle for use as formaldehyde scavengers. The nitrogen-containing stabilizers may be used individually or in combination. Acid scavengers suitable in principle are any of the metal salts of a carboxylic acid. Any of the mono- or divalent metal ions is possible, but preference is given to alkali metals and alkaline earth metals. The carboxylic acids advantageously have from 3 to 18 carbon atoms. Preference is given to propionates, citrates, and pyruvates. Particular preference is given to calcium citrate, magnesium stearate, or calcium propionate. Other materials which may advantageously be used as acid scavengers are silicates, such as Ambosol 500 from Clariant, a synthetic magnesium silicate.

The additives D) listed above may be used individually or in a mixture with one another.

The polyacetal molding composition of the invention may be prepared in a manner known per se by mixing the components, preferably in an extruder.

The molding composition of the invention has low emission and good mechanical properties, and rapid crystallization permits a higher production speed, e.g. during injection molding.

The examples below are intended to illustrate the invention for the skilled worker and to disclose other advantageous embodiments, without limiting the scope of protection.

### EXAMPLES

The base material used comprised polyoxymethylene copolymer with an MVR of 9, with 3.4% of dioxolane as comonomer. Other additives used were 0.2% by weight of Licowax C as flow promoter, 0.30% by weight of Irganox 245, 0.10% by weight of calcium citrate as acid scavenger, and 0.05% by weight of Eurelon 975 as formaldehyde scavenger. Hostaform T1020 was used as polyoxymethylene terpolymer C). This material is a polymer of trioxane, 1,3-dioxolane, and 1400 ppm of the 1,4-bisglycidyl ether of butanediol. Naintsch A7 talc from Luzenac was used as nucleating agent B). Formaldehyde emission was determined as follows to VDA 275. Test specimen preparation: The polyacetal pellets are molded by injection molding to give plaques of dimensions 80*50*1 mm. A Kraus Maffei KM 120/340B injection molding machine is used with the following injection-molding parameters: melt temperature 195° C., flow front velocity 200 mm/s, mold wall temperature 85° C., hold pressure 900 bar, hold pressure time 30 s, cooling time 10 s, back pressure from 0 to 10 bar. Prior to the test, the test specimens are stored for 24 h in a cabinet providing standard conditions of temperature and humidity at 23° C. and 50% relative humidity.

Test: Two test specimens are suspended over 50 ml of demineralized water on a stainless steel hook in a 1 l glass flask, and stored for 3 h in a circulating-air drying cabinet at 60° C. The test specimens are removed from the test flask. 5 ml of test solution are pipetted into a test tube, and the test tube is conditioned for 10 minutes at 95° C. 3 ml of acetylacetone and 3 ml of a 20% strength ammonium acetate solution are then added to the test tube. With the reagent, the formaldehyde forms the diacetyldihydrolutidine complex, the absorption of which at 412 nm is determined photometrically. The formaldehyde concentration in the test solution is calculated from the absorption.

Tensile modulus of elasticity was determined from tensile tests to DIN ISO 527 as a measure of mechanical properties. Crystallization half-life time (CHL) was determined as follows as a measure of crystallization rate: The crystallization of thin POM films (thickness from about 10 to 100 μm) melted at 200° C. is followed using a photocell in a polarization microscope after rapid cooling to 152° C. The crystallization half-life time is given by the period between visually recognizable start of crystallization and the juncture at which the light intensity reaches half of the maximum.

The inventive examples 1 and 2 show reduced formaldehyde emission with respect to non-nucleated and, respectively, talc-nucleated material, and reduced crystallization half-life time (CHL), while mechanical properties are comparable (comparable modulus of elasticity).

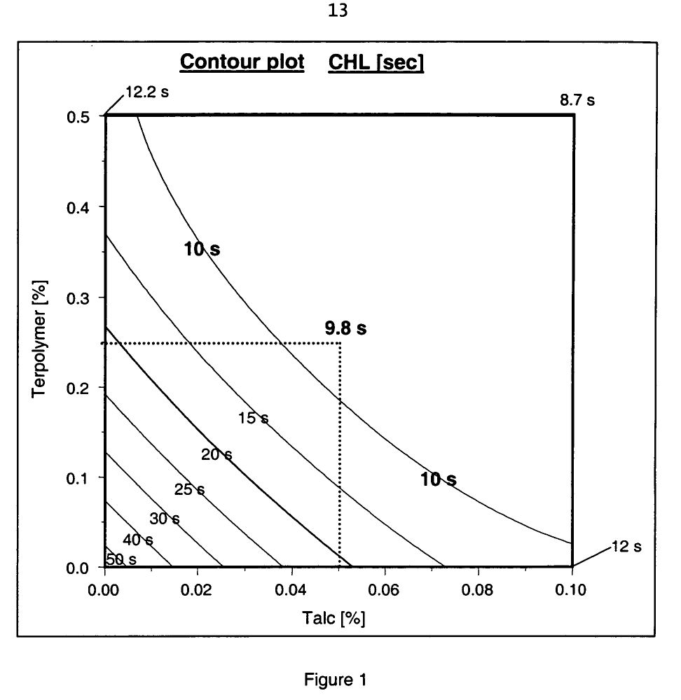

FIG. 1 plots the crystallization half-life times in the form of a contour plot as a function of content of talc and terpolymer, to illustrate the synergistic effect.

TABLE 1
Mixing specifications for examples and comparative examples

| | | Other | | |
|---|---|---|---|---|
| | POM % | additives | Terpolymer | Talc % |
| | by weight | % by weight | % by weight | by weight |
| Comparative | 99.35 | 0.65 | 0 | 0 |
| example 1 | | | | |
| Vergleichsexample | 98.85 | 0.65 | 0.50 | 0 |
| 2 | | | | |
| Example 1 | 99.05 | 0.65 | 0.25 | 0.05 |
| Example 2 | 98.75 | 0.65 | 0.50 | 0.10 |
| Comparative | 99.25 | 0.65 | 0 | 0.10 |
| example 3 | | | | |

TABLE 2
Results of experiments

| | | VDA | CHL | Modulus of |
|---|---|---|---|---|
| | | 275 | (152° C.) | elasticity |
| | Nucleation | ppm | sec | Mpa |
| Comparative | Without | 69.5 | 56 ± 11 | 3275 ± 160 |
| example 1 | | | | |
| Comparative | 0.5% | 38.6 | 12.2 ± 2.5 | 3300 ± 120 |
| example 2 | terpolymer | | | |
| Example 1 | 0.25% | 36.9 | 9.8 ± 0.3 | 3070 ± 40 |
| | terpolymer + | | | |
| | 0.05% talc | | | |
| Example 2 | 0.5% | 57.8 | 8.7 ± 0.3 | 3120 ± 60 |
| | terpolymer + | | | |
| | 0.1% talc | | | |
| Comparative | 0.1% talc | 60.2 | 12.0 ± 0.5 | 3080 ± 95 |
| example 3 | | | | |

1. A thermoplastic molding composition comprising
A) polyoxymethylene homo- or copolymer,
B) nucleating agent other than C),
C) polyoxymethylene terpolymer, and
D) other additives,
where the total of the percentages by weight of a) to d) is always 100%.

2. The thermoplastic molding composition comprising
A) from 25 to 99.9% by weight of a polyoxymethylene homo- or copolymer
B) from 0.0001 to 1% by weight of a nucleating agent other than C),
C) from 0.001 to 5% by weight of a polyoxymethylene terpolymer, and
D) up to 70% by weight of other additives,
where the total of the percentages by weight of A) to D) is always 100%.

3. The thermoplastic molding composition comprising
A) from 50 to 99.8% by weight of a polyoxymethylene homo- or copolymer
B) from 0.001 to 0.8% by weight of a nucleating agent other than C),
C) from 0.01 to 3% by weight of a polyoxymethylene terpolymer, and
D) up to 50% by weight of other additives,
where the total of the percentages by weight of A) to D) is always 100%.

4. The thermoplastic molding composition comprising
A) from 60 to 99.5% by weight of a polyoxymethylene homo- or copolymer
B) from 0.01 to 0.3% by weight of a nucleating agent other than C),
C) from 0.05 to 1% by weight of a polyoxymethylene terpolymer, and
D) up to 40% by weight of other additives,
where the total of the percentages by weight of A) to D) is always 100%.

5. The thermoplastic molding composition comprising
A) up to 99.25% by weight of a polyoxymethylene homo- or copolymer
B) from 0.02 to 0.1% by weight of a nucleating agent other than C),
C) from 0.1 to 0.5% by weight of a polyoxymethylene terpolymer, and
D) other additives comprising 0.2% by weight of flow promoter and/or lubricant, 0.3% by weight of a sterically hindered phenol compound, 0.10% by weight of acid scavenger, and 0.05% by weight of formaldehyde scavenger,
where the total of the percentages by weight of A) to D) is always 100%.

6. The thermoplastic molding composition as claimed in one or more of claims 1 to 5, where talc is used as component B).

7. The thermoplastic molding composition as claimed in one or more of claims 1 to 6, comprising, as additive D), up to 2% by weight of a sterically hindered phenol compound and/or up to 1.0% by weight of a stabilizer selected from the group consisting of the benzotriazole derivatives and benzophenone derivatives, and/or up to 0.5% by weight of a sterically hindered amine (HALS) for light-stabilization.

8. A process for shortening the crystallization time of a polyoxymethylene molding composition, using a combination of talc and polyoxymethylene terpolymer as nucleating agent.

9. The use of a thermoplastic molding composition as claimed in one or more of claims 1 to 7, for producing fibers, films or moldings.

10. A molding obtainable from the thermoplastic molding compositions as claimed in any of claims 1 to 7.
